(19) United States
(12) Patent Application Publication
(10) Pub. No.: US 2006/0206615 A1
(43) Pub. Date: Sep. 14, 2006

(54) Systems and methods for dynamic and risk-aware network security

(76) Inventors: Yuliang Zheng, Charlotte, NC (US); Lawrence Chin Shiun Teo, Charlotte, NC (US); Gail-Joon Ahn, Harrisburg, NC (US)

Correspondence Address: KILPATRICK STOCKTON LLP - 46872;J. STEVEN GARDNER, 1001 WEST FOURTH STREET, WINSTON-SALEM, NC, 27101, US

(21) Appl. No.: 10/553,306

(22) PCT Filed: May 30, 2003
(86) PCT No.: PCT/US03/16817

§ 371 Date: Oct. 14, 2005

(51) Int. Cl. G06F 15/16

(52) U.S. Cl. 709/229

(57) ABSTRACT

Systems and methods for dynamic and risk-aware network security are described. In one embodiment, a system dynamically assesses whether a connection over a communications medium (102) is anomalous (suspicious, malicious, deviating from normal behavior, fits a certain profile or pattern, or has the potential to be any one of these) and generates an appropriate response depending on whether the connection is deemed to be normal or anomalous for a specified period of time. The types of responses include, but are not limited to, blocking the source of the connection from connecting to its intended destination, altering the destination of the connection, auditing the connection, or any combination of these.

### NOTICE OF COPYRIGHT PROTECTION

A portion of the disclosure of this patent document and its figures contain material subject to copyright protection. The copyright owner has no objection to the facsimile reproduction by anyone of the patent document, but otherwise reserves all copyrights whatsoever.

### FIELD OF THE INVENTION

This invention relates to the field of information assurance and security. More specifically, it relates to the field of firewalls, intrusion detection, network security, and risk assessment.

### BACKGROUND

The Internet has made a vast wealth of resources available to computer users. At the same time, the Internet, by requiring the interconnection of millions of computers, has created a substantial need for computer network security. A key element in securing a network is a firewall.

In order to provide efficient and effective security, firewalls must make determinations of whether to block or allow packets based on rules. Historically, firewalls have relied upon static rules to determine whether or not to allow a packet. For example, the rules entered into a static firewall typically include a list of valid Internet protocol (IP) addresses. When the firewall receives a packet from one of these IP addresses, the firewall allows the packets to pass through. Firewalls typically maintain a similar list of ports through which packets may pass. The use of static rules for filtering packets is insufficient for effectively securing a network.

Firewall developers have tried several approaches to improve conventional firewalls. For example, some conventional firewalls include a technique called stateful inspection, see, e.g., Sofaware Technologies (http://www.sofaware.com/html/tech_stateful.shtm) and Check Point™ Software's FireWall-1 (www.checkpoint.com).

Stateful inspection is a technique that uses state-related information from the network and network-related applications to make control decisions, instead of examining each packet in isolation. While stateful inspection improves the filtering of potentially malicious packets, conventional firewalls implementing this technique rely on only a limited set of information sources.

Other conventional firewalls have relied on network management techniques for improving the capabilities of firewalls. See for example: Antur, et al. “Method and apparatus for reconfiguring and managing firewalls and security devices”, U.S. Pat. No. 6,243,815, Jun. 5, 2001; Gai, et al. “Method and apparatus for defining and implementing high-level quality of service policies in computer networks”, U.S. Pat. No. 6,167,445, Dec. 26, 2000; and Fink, et al. “System, device and method for rapid packet filtering and processing”, U.S. Pat. No. 6,496,935, Dec. 17, 2002.

None of the conventional techniques for creating firewalls provides a dynamic, risk-aware method of managing network access.

### SUMMARY

Embodiments of the present invention provide systems and methods for dynamic and risk-aware network security. In one embodiment, a system dynamically assesses whether a connection over a communications medium is anomalous (suspicious, malicious, deviating from normal behavior, fits a certain profile or pattern, or has the potential to be any one of these) and generates an appropriate response depending on whether the connection is deemed to be normal or anomalous for a specified period of time. The types of responses include, but are not limited to, blocking the source of the connection from connecting to its intended destination, altering the destination of the connection, auditing the connection, or any combination of these.

An embodiment of the present invention may comprise software or a pre-programmed device or it may be integrated into another software product or device.

A network device according to the present invention is capable of analyzing one or more connections at any one time; theoretically there is no maximum number of connections that the device can analyze. When a connection arrives on a communications medium, the device examines a set of inputs and/or performs a set of actions in the environment in which the communications medium is located. Based on these inputs and results of the actions, the device determines if the connection is anomalous or not. If the connection is assessed to be anomalous, the risk measurement for the identifier of the connection (such as the name of the source) is adjusted (increased or decreased) by a certain amount. Once the risk measurement for a connection identifier reaches or exceeds a certain specified threshold, an appropriate response is generated for all future connection that are identified by that identifier. The risk measurement can also be adjusted if the connection is determined to be normal.

A set of policies, which may be human-defined and/or machine-generated, is used to specify the risk measurement adjustment amounts, the types of connections to examine, the appropriate responses, the inputs, the actions, the time periods, specific attributes of the communications medium, specific attributes of the environment, and other elements that are deemed necessary or beneficial to the risk assessment and dynamic response device according to the present invention

Among the applications that an embodiment of the present invention can be used for include, but are not limited to, adaptive and intelligent firewalls, intrusion detection systems, load balancing systems, network traffic control, and reputation-based systems in various environments.

Embodiments of the present invention provide numerous advantages over conventional network access management solutions. An embodiment of the present invention utilizes a wide variety of applications, policies, and other information to make more intelligent and accurate decisions. Also, embodiments of the present invention provide a role-based approach to network management that is independent of the actual network protocols used. Embodiments of the present invention use the concepts of roles, risk, and other attributes to describe and characterize the nodes in the network. Also, an embodiment of the present invention is not limited to implementation in firewalls. Further, if an embodiment is implemented as a firewall, the firewall uses more varied sources of information than do conventional firewalls and is capable of initiating active countermeasures in response to an anomalous connection.

Further details and advantages of the present invention are set forth below.

### BRIEF DESCRIPTION OF THE FIGURES

These and other features, aspects, and advantages of the present invention are better understood when the following Detailed Description is read with reference to the accompanying drawings, wherein:

FIG. 1 is a block diagram, illustrating an exemplary environment for implementation of one embodiment of the present invention;

FIG. 2 is a timing diagram illustrating the flow of information in one embodiment of the present invention;

FIG. 3 is a diagram illustrating how roles are used to assign node and service values in one embodiment of the present invention;

FIG. 4 is a diagram illustrating various attributes of the static and dynamic data stores in one embodiment of the present invention;

FIG. 5 is a flow diagram illustrating the simulation flow for the creation of graphical output in one embodiment of the present invention;

FIG. 6 is a graph plot showing traffic with a normal profile in one embodiment of the present invention;

FIG. 7 is a graph plot showing traffic with a suspicious profile in one embodiment of the present invention; and

FIG. 8 is a graph plot showing traffic with a highly malicious profile in one embodiment of the present invention.

### DETAILED DESCRIPTION

An embodiment of the present invention provides a new mechanism that dynamically assesses whether a connection over a communications medium is anomalous (suspicious, malicious, deviating from normal behavior, fits a certain profile or pattern, or has the potential to be any one of these) and generates an appropriate response depending on whether the connection is deemed to be normal or anomalous for a specified time period. Unlike other similar mechanisms that perform such tasks, the invention uses risk as an input along with several forms of management and enforcement policies.

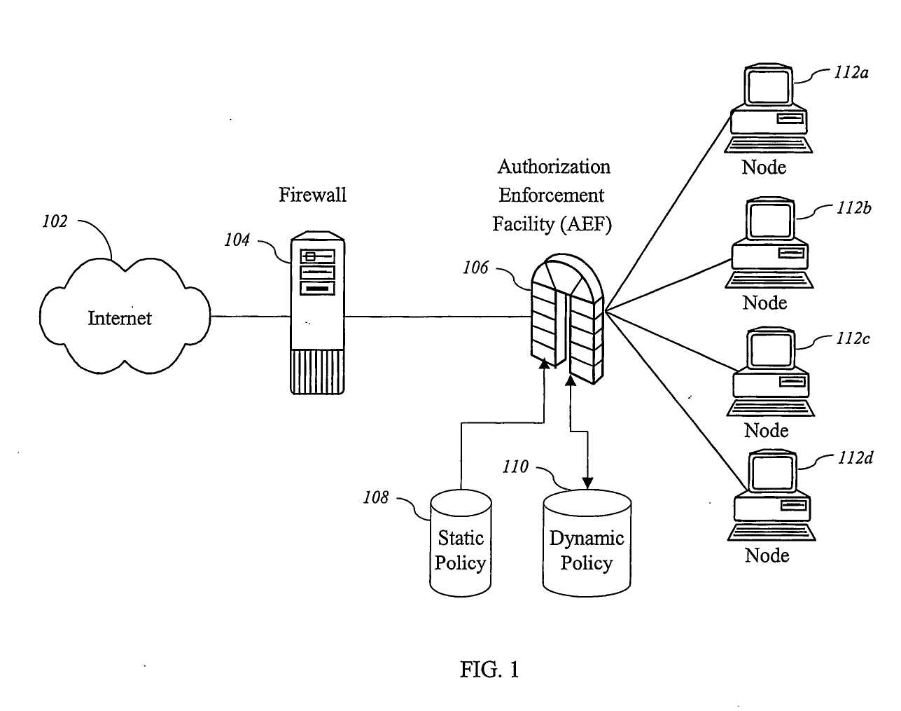

Referring now to the figures in which like numerals indicate like elements throughout the several figures, FIG. 1 is an exemplary environment for implementation of one embodiment of the present invention. In the embodiment shown, an organization accesses the Internet 102 through a firewall 104. The firewall 104 provides basic network security as is well known to those skilled in the art.

The firewall 104 is in communication with an Authorization Enforcement Facility (hereinafter “AEF”) 106. As is described in further detail below, the AEF 106 extracts policy information from a static policy data store 108 and a dynamic policy data store 110 in order to evaluate threats to resources in the network caused by connections. A connection is an active state of communication between a source and a node on the communications medium, which is valid for a certain time period. A connection can be identified using a connection identifier. A common connection identifier for a connection is the source address.

In an embodiment of the present invention, the AEF 106 comprises program code stored on a computer-readable medium. A processor in the AEF 106 executes the program code. The processor may include, for example, digital logic processors capable of processing input, executing algorithms, and generating output as necessary in response to the inputs received from the touch-sensitive input device. Such processors may include a microprocessor, an ASIC, and state machines. Such processors include, or may be in communication with, media, for example computer-readable media, which stores instructions that, when executed by the processor, cause the processor to perform the steps described herein.

Embodiments of computer-readable media include, but are not limited to, an electronic, optical, magnetic, or other storage or transmission device capable of providing a processor, such as the processor in communication with a touch-sensitive input device, with computer-readable instructions. Other examples of suitable media include, but are not limited to, a floppy disk, CD-ROM, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel both wired and wireless. The instructions may comprise code written in any computer-programming language, including, for example, C, C++, C#, Visual Basic, Java, and JavaScript.

The program code of an embodiment of the present invention may be implemented in a variety of applications, including, but not limited to: a hardware appliance, software on a server, software on a firewall, a smart router, a smart gateway, a smart switch, electronic circuitry on a circuit board, a mobile device, and a wireless device.

Referring again to FIG. 1, these threats may originate from many different sources either external, from the Internet 102 for example, or internal from nodes 102a-d. A source is a system, software, or device that initiates a connection using a communications medium, such as the Internet 102. When a node is connecting to another node using a communications medium in an enclosed environment (such as a corporate LAN), the node that initiates the connection would be known as the source. Whenever there is ambiguity, a node that acts the destination may also be referred to as a “destination node.” A node is a system, software, or device that is the destination of a connection. Some nodes provide services. A service is a function, facility, or capability that is offered by a node. In the embodiment shown, nodes 102a-d are computer workstations. As the AEF 106 analyzes connections in the network, the AEF 106 dynamically adjusts the policies stored in the dynamic policy data store 110 based on the AEF's 106 analysis of the risk level and other criteria as described herein.

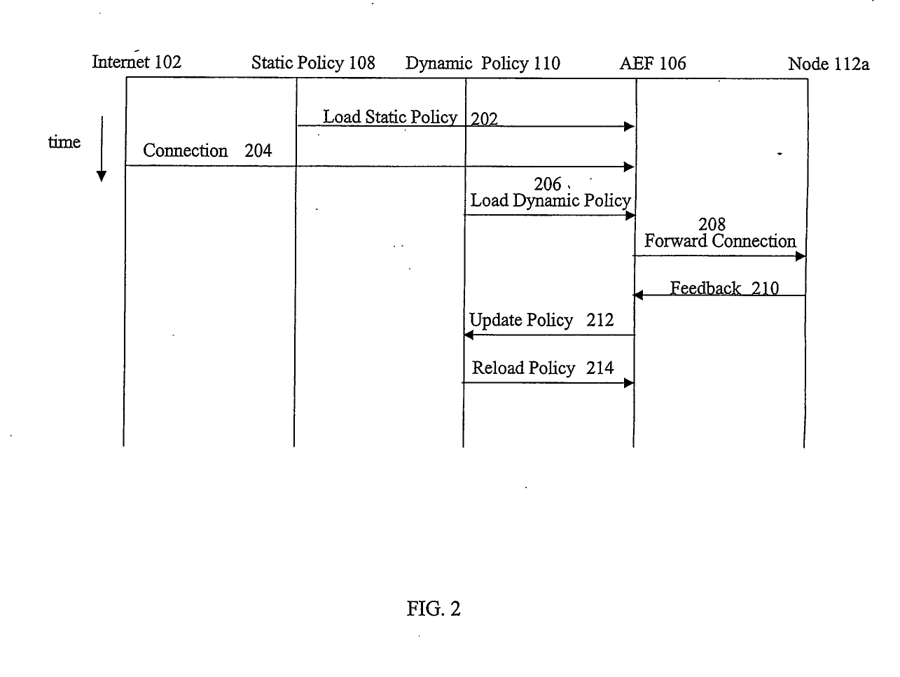

FIG. 2 is a timing diagram, illustrating the flow of messages in an embodiment of the present invention. When the AEF (106) is started, it loads policy information from the static policy data store (110) 202. Subsequently, the AEF (106) receives a connection from the Internet (102) 204. In response the AEF (106) loads information from the dynamic policy data store (110) 206. Depending on the size of the data store (110), the AEF (106) may load all of the policy information or only that policy information related to the connection. If the connection is not anomalous, the AEF (106) forwards the connection the node to which it was directed (112a) 208.

When the node (112a) receives the connection, the node (112a) may provide feedback to the AEF(106) 210. For example, the connection may contain a virus, such as a worm. In response to the feedback, the AEF (106) updates the policy information in the dynamic policy data store (110) 212. In the embodiment shown, the AEF (106) then reloads the updated policy information from the dynamic policy data store (110) 214.

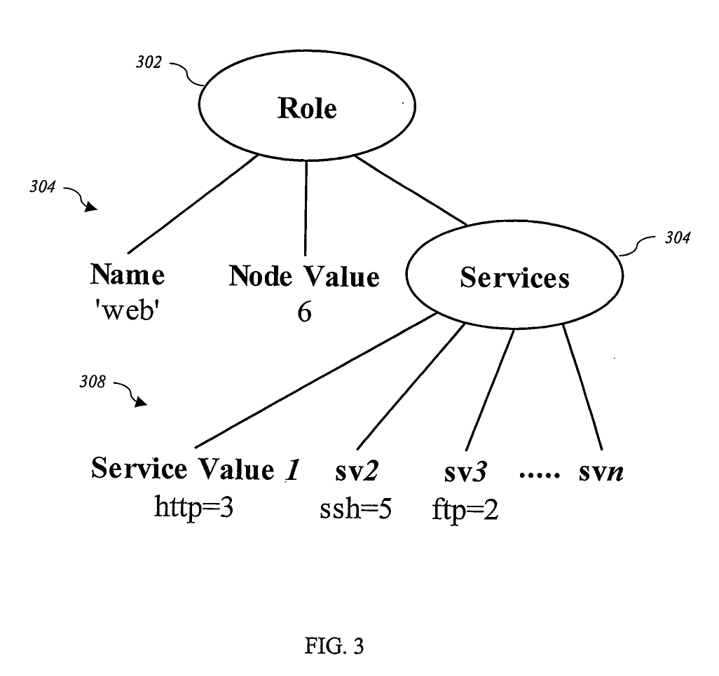

FIG. 3 is a diagram illustrating how roles are used to assign node and service values in one embodiment of the present invention. A role is a structure that can be used to identify a node, and provide the node with its name, node value, available services for the node, and the service values for these said services. FIG. 3 shows an example of a role 302 for a web server, which would be applicable if the invention is used in a computer network environment. The role 302 includes various attributes 304. In the embodiment shown, the attributes 304 include the name, ‘web,’ and the node value, 6. A node value specifies how valuable a node is in a quantitative manner. Depending on the policies and/or constraints in the environment in which an embodiment of the invention is used, the node value can either be finite or infinite.

The role 302 also has at least one service 306 associated with it. The service also includes attributes 308. One of the attributes 308 is the service value. A service value specifies how valuable a service is in a quantitative manner. Depending on the policies and/or constraints in the environment in which the embodiment of the invention is used, the service value can either be finite or infinite.

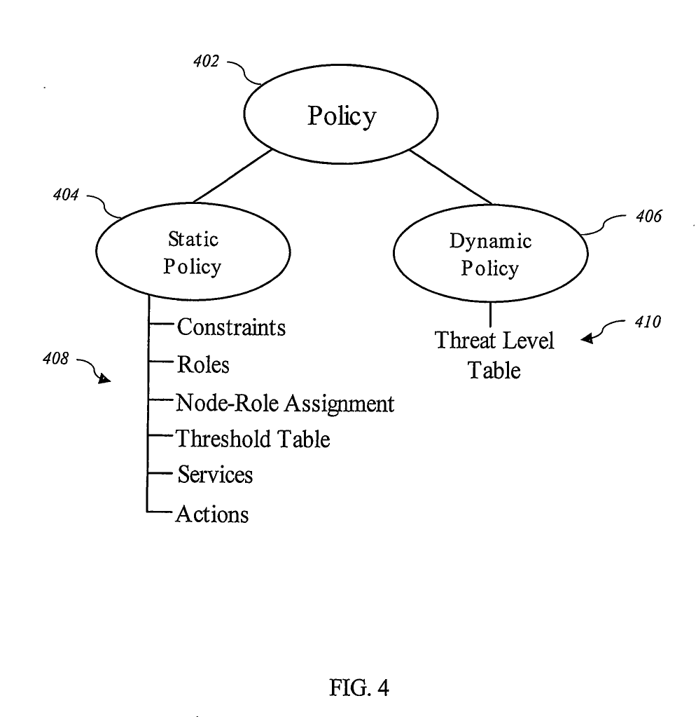

FIG. 4 is a diagram illustrating various attributes of the static and dynamic data stores in one embodiment of the present invention. In the embodiment shown, the overall policy 402 of the AEF (106) comprises static policy 404 and dynamic policy 406. Static policy 404 comprises various attributes 408, including constraints, roles, node-role assignments, a threshold table, services, and actions. These attributes 408 may comprise tables in a database, rules programmed into business objects, or other methods for storing and enforcing rules in a software application. Static policy 404 may comprise additional attributes as well. In the embodiment shown, dynamic policy 406 comprises a single attribute, a threat level table 410. This is merely exemplary. Both the static policy 404 and dynamic policy may include subsets or supersets of the attributes shown in FIG. 4.

One attribute 408 of the static policy 404 is an action. An action has two purposes: the first is to adjust the threat level of a source, and the second is to act as a countermeasure that is triggered as a result of an event. Countermeasures can be either active or passive. Active countermeasures enable the destination node to send either asynchronous messages or queries, which solicit a response from the source. Passive countermeasures rely on methods, which do not send any messages to the source whatsoever (the source would not know that a countermeasure has taken place).

A threat level is a quantitative measure that specifies how anomalous a source or any other connection identifier is. The higher the threat level, the more suspicious the connection identifier is. The threat level can also be thought of as the risk associated with the source. Whether or not a connection is allowed to pass through the AEF (106) is a function of the threat level of the node/service and of the threshold. A threshold is a quantitative measure specifies how tolerant a node is to anomalous behavior. A threshold is assigned to a node based on its node value. The higher the node value, the lower its threshold, which in turn means that the said node exhibits less tolerance to anomalous behavior. The process of evaluating a threat based on the threat value and the threshold is described in greater detail below.

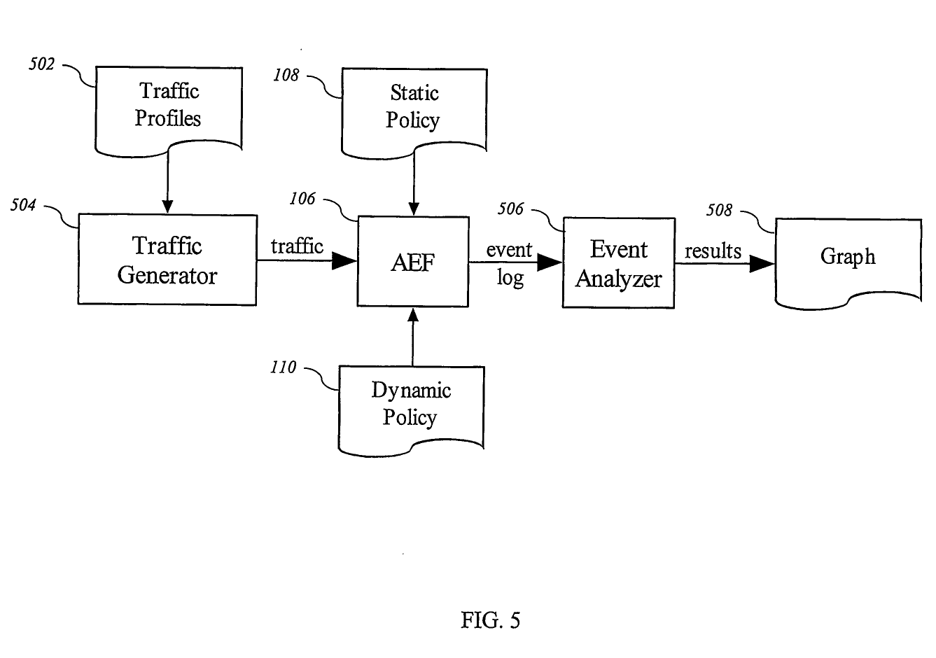

FIG. 5 is a flow diagram illustrating the simulation flow resulting in the creation of graphical output in one embodiment of the present invention. The flow diagram of FIG. 5 provides one example of a method of testing the effectiveness of the AEF (106) according to the present invention. In the embodiment shown, traffic profiles are stored in a traffic profile data store 502. These profiles represent various types of anomalous and non-anomalous (normal) connections that may be attempted. A traffic generator 504 accesses the traffic profile data store 502 in order to generate a series of connections to the AEF 106.

As described in relation to FIG. 1, the AEF 106 extracts information from the static policy data store 108 and the dynamic policy data store 110 to determine how to handle a connection.

If the connection is anomalous, the threat level for the source address of that connection (its connection identifier) is increased by an amount defined by an administrator-defined policy. Access will be granted for source k to connect to service j for node i if:
threatLevel(k)<=nodeThreshold(i) AND threatLevel(k)<=serviceThreshold(i,j)

Threat levels increase as a result of events, which trigger actions. As described above, actions might adjust threat levels. For example, the following statement can be specified in an action to enable the action to increase the threat level for a source by a 1.5:
tlᵢ₊₁=tlᵢ+1.5

The two types of policies, static policies and dynamic policies, are used to support the analysis. The static policy provides rules to the mechanism so that it can perform its decision making. The dynamic policy is updated by the mechanism in real-time to keep track of the threat levels of all the sources.

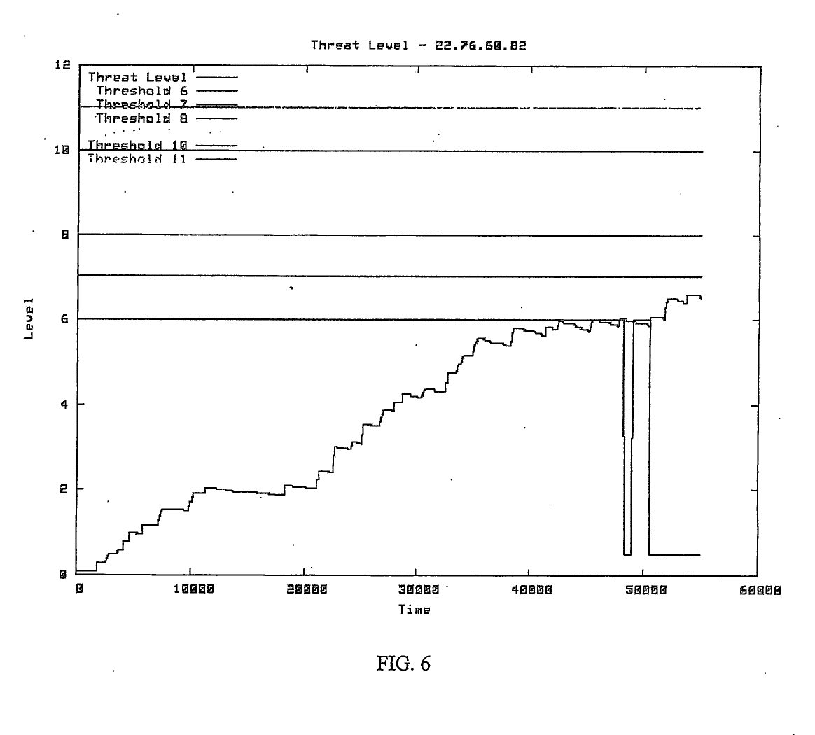

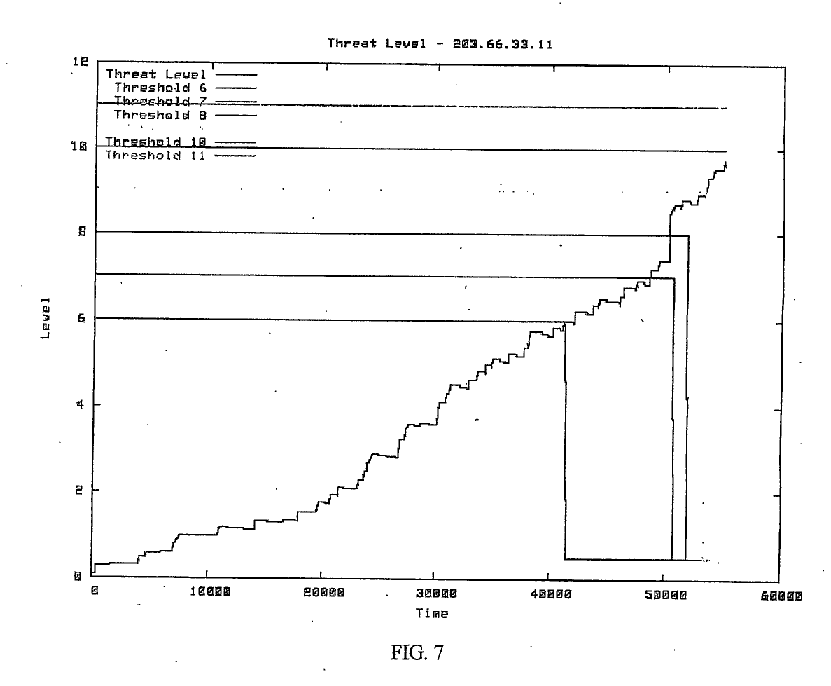

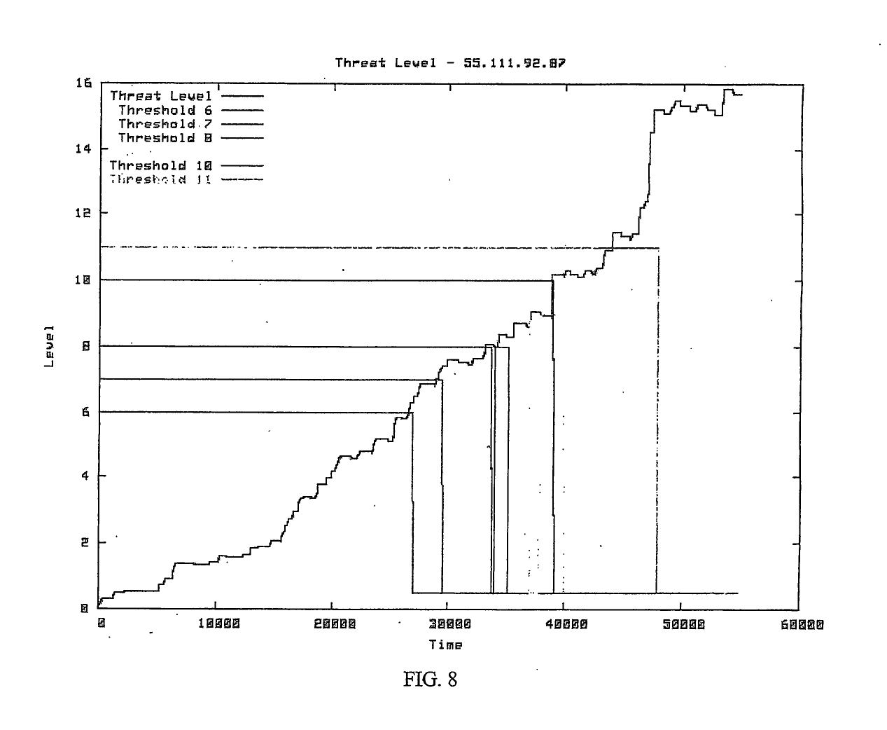

Referring again to FIG. 5, in the embodiment shown, the AEF 106 provides event logs to an event analyzer 506. The event analyzer 506 processes these logs and generates a graph of the results 508. FIGS. 6, 7, and 8 are examples of the graphs produced by one embodiment of the present invention. FIG. 6 is a graph plot showing traffic with a normal profile in one embodiment of the present invention. FIG. 7 is a graph plot showing traffic with a suspicious profile in one embodiment of the present invention. And FIG. 8 is a graph plot showing traffic with a highly malicious profile in one embodiment of the present invention.

In a production (as opposed to simulation) embodiment of the present invention, the AEF 106 may respond to threats in a number of ways. The types of responses may include, but are not limited to: blocking the source of the connection from connecting to its intended destination (authorization enforcement), altering the destination of the connection, auditing the connection, or any combination of these.

The AEF 106 according to the present invention may use a variety of methods to adjust the threat level for a certain node, including, for example, the following:
Obtain the passive fingerprint of the operating system of the connection source. Based on this operating system information, checking to see if the packet that arrives fits the criteria of packets for that operating system. This information can also be used to identify the scans that originate from a certain source.
Check DNS records to see if an internal node accesses the DNS server if it connects to another internal node for the first time (without timeout). If not, then the source node may be suspicious;
Use high-level heuristic rules to determine if a network connection is normal or not. For example, determine whether or not the source ports are incrementing, whether the connection looks like a port scan; and whether the sequence number has been encountered before;
Match the pattern of the connection with a database of intrusion detection system (IDS) signatures. If there are matches, this may be a malicious attack happening. Increase the threat level and if it gets worse, block it;
If a certain node is supposed to be switched off, but a destination node still receives connections from the node, then something malicious may be occurring;
Check user behavior at the nodes. If one node connects to another, but the source node has no users or has users at abnormal hours, then the threat level for the source node may be raised;
Keep a log of incoming and outgoing data per node. If Node A receives traffic from Node B at time t, but Node B does not have logs of that outgoing data at approximately time t, then the threat level for Node B may be raised;
Check user's actions on a node to see if there are any commands that look malicious;
Ping the source node to see if it is alive. If it is not, but it is still sending data, then something wrong may be going on; and
Check the bandwidth of the connection initiated by the source node and match it with the type of traffic that is coming through. For example, we do not expect high bandwidth utilization for normal traffic compared to applications like video streaming. If normal traffic such as web traffic uses bandwidth utilization that is equivalent to that of multimedia streaming, something may be wrong.

An embodiment of the present invention encompasses an efficient management scheme of nodes using concepts from role-based access control (RBAC) in a context that is specific to this mechanism (Role information—ability to specify values to different nodes). So nodes that are more valuable can have higher values. Also, on embodiment includes an independent and generic interface to carry out countermeasures. Since the interface to apply countermeasures is generic, the mechanism can potentially use input from all layers of the OSI model.

Embodiments of the present invention AEF can reduce the propagation rate for new Internet worms and email viruses within an organization, and ultimately stop the propagation entirely. The AEF may also frustrate and deter persistent attackers who are trying to compromise systems from remote locations. In addition, the AEF can provide monitoring and deter persistent insiders who are trying to misuse or abuse the systems in the organization. In addition, since the AEF uses risk and suspicion in its decision-making, it is able to block new forms of unknown attacks in the future.

The foregoing description of the preferred embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

### Glossary of Terms

Node: A node is a system, software, or device that is the destination of a connection.

Source: A source is a system, software, or device that initiates a connection using a communications medium. When a node is connecting to another node using a communications medium in an enclosed environment (such as a corporate LAN), the node that initiates the connection would be known as the source. Whenever there is ambiguity, a node that acts the destination may also be referred to as a “destination node.”

Service: A service is a function, facility, or capability that is offered by a node.

Node Value: A node value specifies how valuable a node is in a quantitative manner. Depending on the policies and/or constraints in the environment that the invention is used, the node value can either be finite or infinite.

Service Value: A service value specifies how valuable a service is in a quantitative manner. Depending on the policies and/or constraints in the environment that the invention is used, the service value can either be finite or infinite.

Connection: A connection is an active state of communication between a source and a node on the communications medium, which is valid for a certain time period. A connection can be identified using a connection identifier. A common connection identifier for a connection is the source address.

Role: A role is a structure that can be used to identify a node, and provide the node with its name, node value, available services for the said node, and the service values for these said services.

Action: An action has two purposes: the first is to adjust the threat level of a source, and the second is to act as a countermeasure that is triggered as a result of an event. Countermeasures can be either active or passive. Active countermeasures enable the destination node to send either asynchronous messages or queries, which solicit a response from the source. Passive countermeasures rely on methods, which do not send any messages to the source whatsoever (the source would not know that a countermeasure has taken place).

Threat Level: A threat level is a quantitative measure that specifies how anomalous a source or any other connection identifier is. The higher the threat level, the more suspicious the connection identifier is. The threat level can also be thought of as the risk associated with the source.

Threshold: A threshold is a quantitative measure specifies how tolerant a node is to anomalous behavior. A threshold is assigned to a node based on its node value. The higher the node value, the lower its threshold, which in turn means that the said node exhibits less tolerance to anomalous behavior.

That which is claimed:

1. A network security system, comprising:
a static policy data store;
a dynamic policy data store;
an authorization enforcement facility (AEF) in communication with said static policy data store and said dynamic policy data store and operable to perform a risk-aware analysis of a connection.

2. The network security system of claim 1, wherein said static policy data store comprises at least one of a constraint, a role, a node-role assignment, a threshold value, a node value, a service value, and an action value.

3. The network security system of claim 2, wherein said threshold value is inversely proportional to said node value.

4. The network security system of claim 2, wherein said threshold value is inversely proportional to said node value.

5. The network security system of claim 1, wherein said dynamic policy data store comprises a threat level table.

6. The network security system of claim 1, wherein said AEF is further operable to generate a response to said connection.

7. The network security system of claim 6, wherein said response comprises at least one of blocking the source of said connection from connecting to an intended destination, altering said intended destination of said connection, and auditing said connection.

8. The network security system of claim 1, wherein said AEF is further operable to generate a countermeasure.

9. The network security system of claim 8, wherein said wherein said countermeasure comprises an active countermeasure or a passive countermeasure.

10. The network security system of claim 1, wherein said AEF comprises a router, a gateway, a hardware appliance, or a web server.

11. The network security system of claim 1, further comprising a firewall in communication with said AEF.

12. The network security system of claim 1, further comprising an intrusion detection system in communication with said AEF.

13. A method comprising:
receiving a static policy data attribute from a static policy data store;
receiving a connection request directed to a node;
receiving a dynamic policy data attribute from a dynamic policy data store;
determining whether said connection request is anomalous based at least in part on said static policy data attribute and at least in part on said dynamic policy data attribute.

14. The method of claim 13, further comprising responding to said connection request.

15. The method of claim 14, wherein responding comprises at least one of forwarding said connection request to said node; blocking the source of said connection from connecting to an intended destination, altering said intended destination of said connection, and auditing said connection.

16. The method of claim 13, further comprising updating said dynamic policy data attribute in said dynamic policy data store based on a result of said determining.

17. The method of claim 13, wherein said updating comprises increasing a threat level if the connection request is determined to be anomalous.
